(19) United States
(12) Patent Application Publication
(10) Pub. No.: US 2004/0043752 A1
(43) Pub. Date: Mar. 4, 2004

(54) Terminal for wireless communication

(75) Inventor: Takashi Matsumura, Yokohama-shi (JP)

Correspondence Address: SCHULTE ROTH & ZABEL LLP, ATTN: JOEL E. LUTZKER, 919 THIRD AVENUE, NEW YORK, NY, 10022, US

(73) Assignee: KYOCERA CORPORATION, Kanagawa-ken (JP)

(21) Appl. No.: 10/449,484

(22) Filed: May 29, 2003

(30) Foreign Application Priority Data
May 31, 2002 (JP) JP2002-159531

(51) Int. Cl. H04M 11/00; H04B 1/38; H04M 1/00

(52) U.S. Cl. 455/405; 455/410; 455/422.1; 455/435.1; 455/558

(57) ABSTRACT

A terminal for wireless communication capable of accommodating a plurality of storage devices, each of the storage devices stores information of a subscriber including telephone numbers. The terminal includes a reading unit which reads the information of the subscriber, a service setting changing unit capable of requesting commencement or termination of a service supplied by network side facilities assigned to each of the information of a subscriber, a switch detection unit which detects switching of the telephone numbers, and a control unit which makes the service setting changing unit request commencement of a service supplied by the network side facilities for telephone numbers that are not used for communication when the switching of the telephone numbers is detected by the switch detection unit, and request termination of a service supplied by the network side facilities for the telephone number that is used for communication.

### BACKGROUND OF THE INVENTION

1. Field of the Invention

This application claims priority from Japanese Patent Application No. 2002-159531 filed on May 31, 2002.

The present invention relates to a terminal for wireless communication. More specifically, the present invention relates to a terminal for wireless communication, such as a mobile phone, which is capable of storing a plurality of information of a subscriber, such as telephone numbers.

2. Description of Related Art

In general, a conventional mobile phone electronically stores an intrinsic terminal number, i.e., a telephone number or a serial number, therein. The terminal number may be used for authentication for connecting to a wireless telephone network or for charging purposes. Also, it is becoming popular in the Global System for Mobile Communications (GSM), which is a mobile phone system mainly used in Europe, and in the International Mobile Telecommunication 2000 (IMT-2000) system, which is called the mobile phone system of the next generation, that IC cards called a Subscriber Identity Module (SIM) and a User Identity Module (UIM) are inserted in a mobile phone so that a connection to a wireless telephone network may be achieved by using a subscriber's information, i.e., information relating to the subscriber, such as telephone numbers and charge information, which is recorded on the IC cards.

By using the IC card in which identification information assigned to the subscriber is recorded, a user can connect to a wireless telephone network using the identification information by inserting the IC card into a mobile phone corresponding to the IC card. For example, suppose a user only has his own IC card, he may borrow a mobile phone from a third party and use the phone by inserting his IC card into the phone so that the phone is connected through the user's contracted circuit. Also, it is not necessary to renew the circuit contract when a user changes his phone to a new one, and it becomes possible to use a new phone by removing his IC card from the old phone and inserting it into the new phone. Moreover, if a user possesses both new and old phones, he may select the phone to use by inserting his IC card into whichever phone he wants to use. Furthermore, it is possible to use a plurality of phones having different purposes, such as a phone for voice communication and a phone which has a personal computer memory card international association (PCMCIA) card which is exclusive to data communication, by adequately selecting one of the IC cards, i.e., one of the contracted circuits.

The above-mentioned IC card is generally obtained by a user by making a contract on a circuit to use with a telephone company (a carrier). Accordingly, it is possible to obtain an IC card from a plurality of different telephone companies whose service area, content, etc., are different, and carry out telephone communications by changing a plurality of IC cards in one telephone device, and selecting a suitable telephone company depending on the location of communication or the desired service.

In the GSM system which is mainly used in Europe and whose service is available in many other countries, a telephone company which offers a service is changed when moving from one country to another country or from one area to another area, and it occasionally happens that the service of a telephone company cannot be received at the destination by using the identification information of the IC card which had been used before arriving at the destination. In such a case, a user can purchase a prepaid type IC card at the destination, for example, and he can receive services from a telephone company located at the destination by inserting the purchased IC card into his telephone device.

When a user wishes to use a plurality of IC cards, i.e., contracted circuits, for one telephone device, it becomes necessary for the user to switch his IC cards when, for instance, a telephone company is changed from one to another during transfer from one place to another. In order to reduce this labor required of the user, a telephone device was proposed in which a plurality of IC cards can be inserted therein and one of the IC cards which is used for communication can be selected. This telephone device has already been realized in the GSM system.

Also, in Japanese Unexamined Patent Application, First Publication (Kokai) No. Hei 11-196463, a telephone device is proposed which is activated when a plurality of IDs (identification codes) which can be used by one telephone device using identification information recorded in the telephone device and identification information recorded in at least one SIM type IC card, by setting a preferred IDs and automatically selecting the ID when the power is turned on. This proposal was made to improve the complicated operation required of a user which is caused when a plurality of IDs are available for a telephone device and it is necessary for the user to select one of the IDs to use.

However, when a plurality of the above-mentioned IC cards are inserted in one telephone device, each of the IC cards cannot always be used at the same time for reasons such as each of the IC cards are in general contracted circuits of different telephone companies and the radio frequency of each IC card is different (for example, 800 MHz area and 1.8 GHz area of the GSM).

Moreover, in a general mobile phone, for example, it is difficult to connect to a plurality of wireless phone networks at the same time using identification information recorded in each of the plurality of IC cards due to problematic factors such as the size of the circuit and the allowable electric current consumption. For this reason, in general, only one card can be used for connecting to a wireless phone network at one time even if a plurality of IC cards are inserted into one telephone device, and identification information, such as telephone numbers, of the rest of the IC cards cannot be utilized. It may be that only one of the telephone numbers available for one telephone device is valid at any one time from the viewpoint that telephone numbers, etc., are assigned to each one of the IC cards.

For example, when someone makes a telephone call to the telephone number of the above-mentioned telephone device, a problem may occur in which the telephone call cannot be received unless the telephone number called is activated in the telephone device at the time the call is made. If the call is not received by the telephone device of the receiver, the caller's telephone device recognizes that the receiver's telephone is outside the receiving area or that the power is not turned on.

On the other hand, a wireless telephone system, such as a mobile phone or car phone, does not basically guarantee that a connectable state is maintained all the time. Accordingly, a telephone answering service, a call forwarding service, etc., are provided mainly by telephone companies in consideration of the situations where a telephone call cannot be connected due to, for example, a receiver being outside the service area, inside a building, present underground, or located at a place where buildings interfere with radiowaves. Note that the network service is supplied using a function provided with the facilities of the telephone network, such as a switch station or a service control station, and not using a function provided inside the telephone device.

Accordingly, a countermeasure may be conceived of for telephone numbers corresponding to IC cards other than the single above-mentioned activated IC card wherein a telephone answering service is provided or a call forwarding service is made available for such telephone numbers so that the call may be forwarded to the activated telephone number.

However, even if such countermeasures are taken, a complicated operation is still occasionally required in which the user must change settings of the telephone answering service, or to start and end the call forwarding service for the telephone numbers corresponding to each of the IC cards, for example, when the IC cards are changed by the operation of the user or the IC card which has been used becomes invalid and is automatically changed to another IC card after moving from one service area to another.

Note that what is set for starting the call forwarding service is the telephone number of the IC card used up until that time, and what is set for terminating the call forwarding service is the telephone number of the new IC and which is going to be used.

### BRIEF SUMMARY OF THE INVENTION

The present invention was made in consideration of the above situation, and an object of the invention is to provide a terminal for wireless communication which is capable of storing a plurality of information of a subscriber, and reducing the labor required of a user for changing the settings for starting or ending a service supplied by a telephone network side, for example.

In order to achieve the above object, the first aspect of the present invention provides: a terminal for wireless communication capable of accommodating a plurality of storage devices, each of the storage devices storing information of a subscriber including telephone numbers, and the terminal including a reading unit which reads the subscriber's information; a service setting changing unit which is capable of requesting commencement or termination of a service supplied by network side facilities assigned to each of the subscriber's information; a switch detection unit which detects switching of the telephone numbers, each of the telephone numbers being used to communicate with a telephone network connected to the network side facilities; and a control unit which makes the service setting changing unit request commencement of a service supplied by the network side facilities for telephone numbers that are not used for communication when the switching of the telephone numbers is detected by the switch detection unit, and request termination of a service supplied by the network side facilities for at least one of the telephone numbers that is used for communication.

According to the above terminal for wireless communication, the labor required of a user for changing settings on services provided by the telephone network side can be significantly reduced since settings changing requests can be automatically performed for a telephone answering service, a call forwarding service, etc., supplied by network side facilities of each telephone number when the terminal for wireless communication, such as a telephone device, switches the telephone number to be used which is contained in the plurality of information of the subscriber.

In another aspect of the present invention, the service supplied by the network side facilities is at least one of a telephone answering service and a call forwarding service.

In yet another aspect of the present invention, the storage devices are IC cards, and a plurality of the IC cards can be accommodated in a removable manner.

In yet another aspect of the present invention, the subscriber's information is stored in a body of the terminal and in at least one IC card which is removably accommodated in the body of the terminal.

In yet another aspect of the present invention, the IC cards are Subscriber Identity Modules or User Identity Modules.

In yet another aspect of the present invention, the service setting changing unit is capable of calling a predetermined telephone number assigned to a corresponding telephone network, and transmitting a predetermined signal to the telephone network.

In yet another aspect of the present invention, the terminal includes a memory unit, and the service setting changing unit is operated based on a procedure recorded in a database formed in the memory unit.

In yet another aspect of the present invention, the service setting changing unit is operated based on a procedure recorded in the IC card.

### BRIEF DESCRIPTION OF THE SEVERAL VIEWS OF THE DRAWINGS

Some of the features and advantages of the invention having been described, others will become apparent from the detailed description which follows, and from the accompanying drawings, in which:

FIG. 1 is a schematic block diagram showing a structure of a telephone device and network side facilities according to an embodiment of the present invention, and

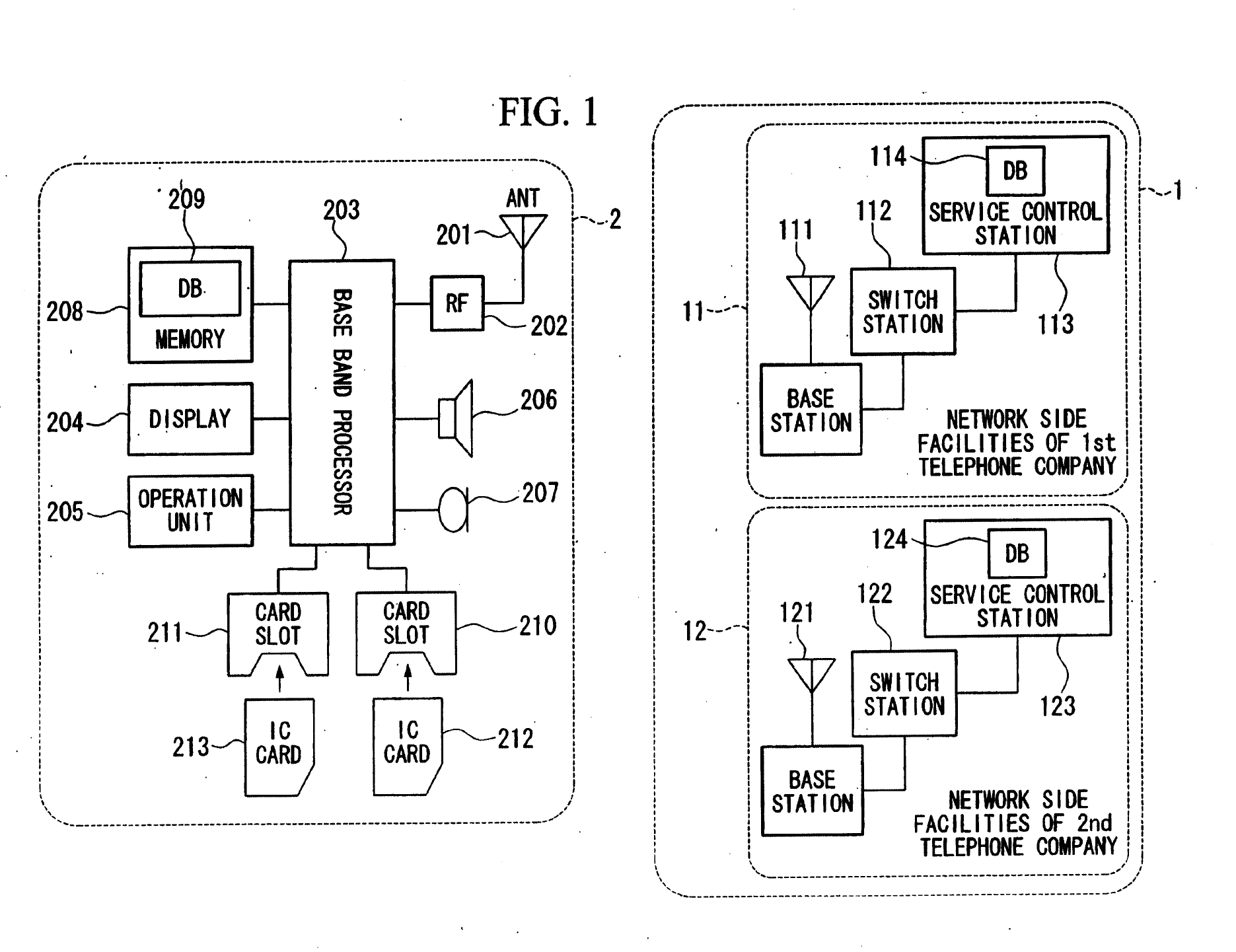

FIG. 2 is a flowchart showing an operation of the telephone device in the embodiment of the present invention.

### DETAILED DESCRIPTION OF THE INVENTION

The invention summarized above and defined by the enumerated claims may be better understood by referring to the following detailed description, which should be read with reference to the accompanying drawings. This detailed description of particular preferred embodiments, set out below to enable one to build and use one particular implementation of the invention, is not intended to limit the enumerated claims, but to serve as a particular example thereof.

Hereinafter, embodiments of the present invention will be explained for each of the structures and the operation.

FIG. I is a block diagram showing a schematic structure of a telephone device and facilities of a network side according to an embodiment of the present invention. In FIG. I, network side facilities 1 include network side facilities of a first telephone company 11 and network side facilities of a second telephone company 12. The network side facilities of the first telephone company 11 include a base station 111 which makes wireless communication with a telephone device, a switch station 112 which selects and connects a circuit so that communication between telephone devices becomes possible, and a service control station 113 which controls subscriber's information, value added services, and so forth. The service control station 113 also includes a database 114 which stores information of a mobile station.

The network side facilities of the second telephone company 12 include a base station 121 which makes wireless communication with a device, a switch station 122 which selects and connects a circuit so that communication between telephone devices becomes possible, and a service control station 123 which controls subscriber's information, value added services, and so forth. The service control station 123 also includes a database 124 which stores information of a mobile station.

Each of the databases 114 and 124 stores a subscriber's information of the corresponding telephone company and retains telephone numbers intrinsic to each telephone device (mobile station), positional information used for a call, setting information for a telephone answering service and a call forwarding service, and so forth.

A telephone device 2 includes an antenna 201, an RF circuit 202, a base band processor 203, a display portion 204 and a key operation portion 205, a handset portion 206, a transmitter portion 207, a memory 208, and two IC card slots 210 and 211. The antenna 201 is used for connection to the base stations 111 and 121 of the network side facilities 1. The base band processor 203 controls not only processing of received and transmitted signals but also the total function of the telephone device. The display portion 204 and the key operation portion 205 function as an interface for a user. The handset portion 206 and the transmitter portion 207 include a speaker and a microphone, respectively. The memory 208 is read and written by the base band processor 203.

The base band processor 203 functions as a reading unit which reads the subscriber's information from an IC card inserted into the IC card slots 210 and 211, as a service setting changing unit which demands a start or a termination of a service supplied by the network side facilities 1, as a switch detection unit which detects switching of telephone numbers used for connecting to a telephone network, and as a control unit which makes the service setting changing unit demand a start of the service supplied by the network side facilities 1 for telephone numbers not used for communication, and demand a termination of the service supplied by the network side facilities 1 for the telephone number used for the communication when switching of the telephone numbers is detected by the switch detection unit.

The memory 208 includes an operation procedure database 209 which retains data showing a procedure for demanding a start or a termination of the services supplied by telephone companies, such as a telephone answering service and a call forwarding service, corresponding to the subscriber's information (which includes a telephone number) stored in each of the IC cards. A first IC card 212 in which the subscriber's information that can be used for connecting to the first telephone company is stored, or a second IC card 213 in which the subscriber's information that can be used for connecting to the second telephone company is stored, may be inserted into the IC card slots 210 and 211.

The first IC card 212 and the second IC card 213 are in conformity with SIM or LJIM specifications, and store identification information for telephone companies, telephone numbers, user IDs, charges for communication, etc., as the subscriber's information, and also stores information related to each service, memos, lists of telephone numbers. etc.. as additional information.

The operation procedure database 209 stores procedures for demanding a start or a termination of the services supplied via the network side facilities of the telephone companies, such as a telephone answering service and a call forwarding service, corresponding to the subscriber's information stored in each of the plurality of IC cards which is inserted into the IC card slots 210 and 211 of the telephone device 2. The demanding procedures are set for each of the IC cards. Also, the contents of the demanding procedure include telephone numbers (special numbers for service) called when carrying out a starting or ending procedure of the network service, and sequences of transmitted contents, etc., of a dual tone multi frequency (DTMF) after making a connection. Here, “transmitted contents” means a telephone number of an object of operation, a personal identification number (PIN), operation codes, etc., and “sequence” means an order, timing, and so forth. The telephone number to be called or the sequence of the transmitted contents are either predetermined by the manufacturer of the telephone device, or edited by a user in advance.

Also, the telephone number of the operation object is a telephone number corresponding to each IC card, and it is stored in each IC card. Accordingly, the base band processor 203 reads the telephone number of the operation object from the IC card inserted into the IC card slot 210 or the IC card slot 211, and records it in the operation procedure database 209.

Moreover, the PIN is registered by the operation of a user in advance.

As an example, the contents of the operation procedure corresponding to the first IC card 212 and the second IC card 213. which are stored in the operation procedure database 209. are as follows.

<First IC card 212>

IC card number: 1
IC card intrinsic telephone number: OMM-NNNN-PPPP
Service operation PIN: QQQQ
Operation procedure to start using IC card:
Number called: OAA-AAAA-XXXX

Operation procedure: call ->wait for connection ->transmit “telephone
number intrinsic to IC card” ->transmit “service operation PIN”
-> t ransmit “1” ->end of communication (disconnect)

Operation procedure to end using IC card
Number called: OAA-AAAA-YYYY

Operation procedure.: call -> wait for connection -> transmit
“telephone number intrinsic to IC card” -> transmit “service
operation PIN” -> transmit “1” -> end of communication
(disconnect)

<Second IC card 213>

IC card number: 2
IC card intrinsic telephone number: ORR-SSSS-TTTT
Service operation PIN: UUUU
Operation procedure to start using IC card

Number called: OBB-BBBB-ZZZZ

Operation procedure: call ->wait for connection ->transmit “telephone
number intrinsic to IC card” -> transmit “1” -> transmit “service
operation PIN” -> transmit “1” -> transmit “1” -> transmit “1” ->
end of communication (disconnect)

Operation procedure to end using IC card

Number called: OBB-BBBB-ZZZZ

Operation procedure: call -> wait for connection -> transmit
“telephone number intrinsic to IC card” -> transmit “1” -> transmit
“service operation PIN” -> transmit “1” -> transmit “2” -> transmit
“I” -> end of communication (disconnect)

In the above example of the operation procedure, the first IC card 212 is stored as the IC card number “1” in the operation procedure database 209. Also, the operation procedure database 209 records the IC card intrinsic telephone number “0MM-NNNN-PPPP” which is stored in the first IC card 212 and is used for connecting to the network side facilities of the first telephone company II, the service operation PIN “QQQQ” which is required for the operation (demand) of the service, the number called (special number for service) “OAA-AAAA-XXXX” and the operation procedure which are used for discontinuing the call forwarding service when starting to use the IC card, and the number called “OAA-AAAA-YYYY” and the operation procedure, which are used for starting the call forwarding service when terminating the use of the IC card.

In this embodiment, the term “start using an IC card” means the time when communication with the network side facilities becomes possible by using the subscriber's information stored in the IC card from a state in which the IC card is not used due to reasons that another IC card is in use or the power of the phone is not turned on.

Note that the starting or ending operation procedure is a procedure for controlling (demanding) the service from the service control station 114 of the first telephone company.

Also, in the above example of the operation procedure, the second IC card 213 is stored as the IC card number “2” in the operation procedure database 209 in the same manner as the first IC card 212 except that the IC card intrinsic telephone number and the operation procedure for the second IC card 213 correspond to the network side facilities of the second telephone company 12, and they are used for starting or terminating the telephone answering service.

Differences in the operation procedure of the first IC card 212 and that of the second IC card 213 are not only the numbers to be called. That is, with regard to the start or end of the network service, i.e., the telephone answering service, the call forwarding service, etc., although the service is assigned using the last four digits of the number to call in the first IC card 212, the second IC card 213 is designed so that the service may be assigned after calling the same number using a tone operation. For this reason, the number of tone operations after calling the number increases for the second IC card 213.

Note that “tone operation” in the above-mentioned operation procedure means that the last transmission of “1” indicates, in the case of the first IC card 212, confirmation of switching. The transmission of “1” after inputting the IC card intrinsic telephone number and the service operation PIN indicates, in the case of the second IC card 213, confirmation corresponding to “Is this the right number?”, the transmission of “2” indicates a termination of the service, and the last transmission of “1” indicates confirmation of switching.

Also note that the operation procedure database 209 may store information corresponding to IC cards of other telephone companies, which may be inserted into the IC card slots 210 and 211 of the telephone device 2.

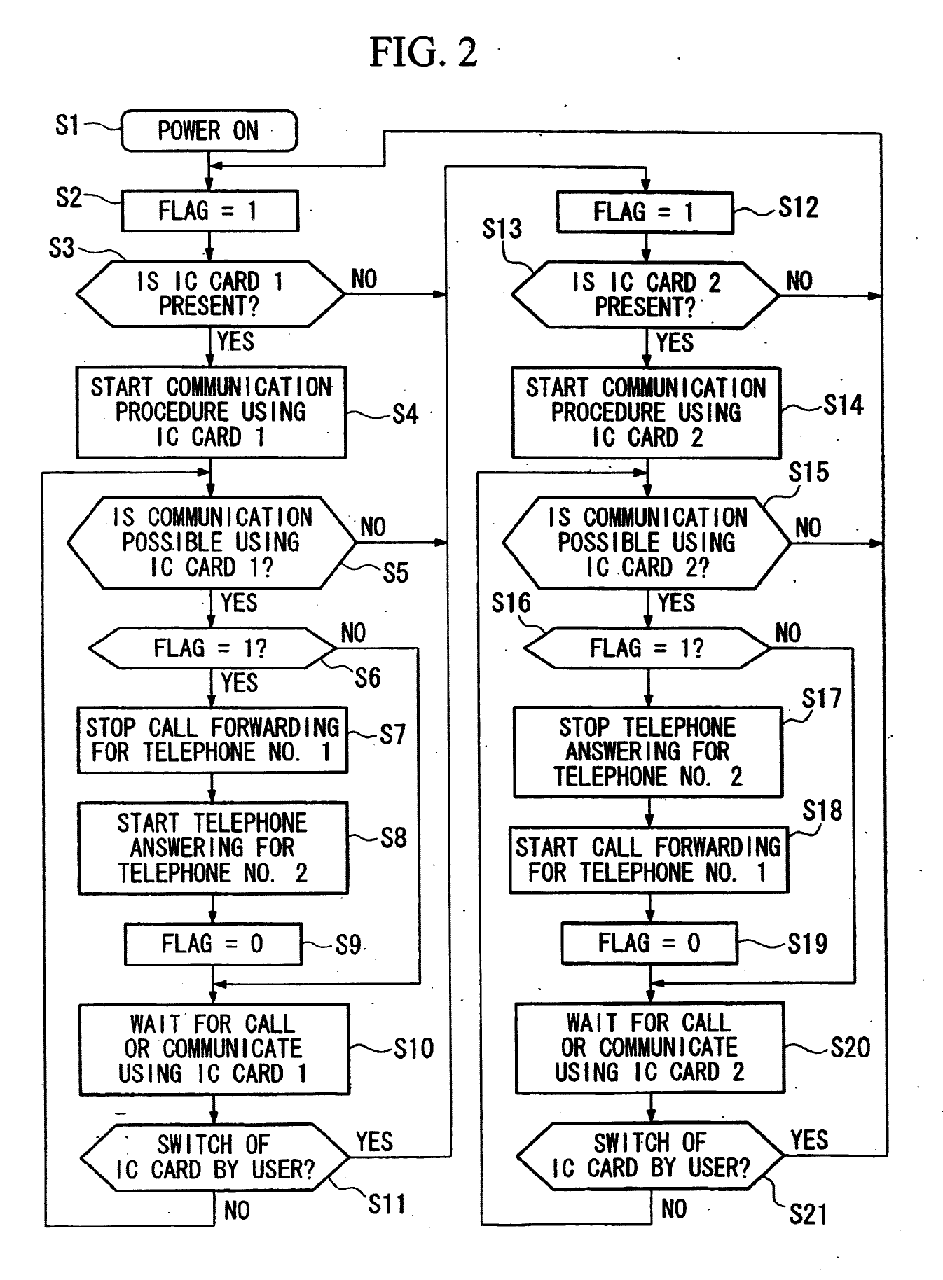

Next, operation of the telephone device 2 having the above-mentioned structure will be explained with reference to FIG. 2. FIG. 2 is a flowchart showing the operation of the telephone device 2. In the operation shown in FIG. 2, steps S2-SII form a process for making communication mainly using the first IC card 212, i.e., IC card “1” and steps S12-S21 form a process for making communication mainly using the second IC card 213. i.e., IC card “2”.

First, the telephone device 2 is powered on (step SI), and after this the base band processor 203 of the telephone device 2 sets “1” for a flag which indicates a change in the IC card used for the telephone device 2 and is information stored in the memory 208 (hereinafter simply referred to as a “flag”) (step S2).

Then, the base band processor 203 determines whether the first IC card 212. i.e., IC card “1”, is inserted into the IC card slots 210 and 211 (step S3).

If it is determined that the first IC card 212 is inserted in step S3. the base band processor 203 reads the subscriber's information from the first IC card 212. and carries out a procedure for transferring to a state in which communication (registration and call waiting) becomes possible by accessing the network side facilities of the first telephone company 11 and sending/receiving predetermined control information (step S4). The base band processor 203 then determines whether the telephone device 2 is in a state unable to communicate due to, for instance, the telephone device 2 being located outside the wireless communication service area (outside range) of the network side facilities of the first telephone company 11 (step S5).

If it is determined that communication is possible in step S5, i.e., when communication with the network side facilities of the first telephone company 11 becomes possible using the subscriber's information of the first IC card 212, the base band processor 203 determines if “1” is set for the flag (step S6).

If it is determined that “1” is set for the flag in step S6, the base band processor 203 reads from the operation procedure database 209 the operation procedure for stopping the call forwarding service supplied by the first telephone company, which corresponds to the telephone number included in the subscriber's information stored in the first IC card 212, and carries out the operation procedure so as to demand the service control station 113 of the first telephone company to stop the call forwarding service (step S7). Then, the 15 service control station 113 operates the database 114 to stop supplying the call forwarding service.

After step S7, the base band processor 203 reads from the operation procedure database 209 the operation procedure for starting the telephone answering service supplied by the second telephone company, which corresponds to the telephone number included in the subscriber's information stored in the second IC card 213 (IC card “2”), and carries out the operation procedure so as to demand the service control station 123 of the second telephone company to start the telephone answering service (step S8). Then, the service control station 123 operates the database 124 to start supplying the telephone answering service.

After step S8, the base band processor 203 sets “0” for the flag (step S9).

Then, the base band processor 203 waits for a call from the network side facilities of the first telephone company 11 or carries out communication using the subscriber's information of the first IC card 212 (step S10).

After step S10, the base band processor 203 determines whether a change (switch) of the IC cards is carried out by the operation of a user (step S11).

If it is determined that a change of the IC cards is not carried out in step S11, the process returns to the above-mentioned step S5.

On the other hand, if it is determined that a change of the IC cards is carried out in step S11, the base band processor 203 sets “1” for the flag (step S12).

Then, the base band processor 203 determines whether the second IC card 213 (IC card “2”) is inserted into the IC card slots 210 and 211 (step S13).

If it is determined that the second IC card 213 is inserted in step S13, the base band processor 203 reads the subscriber's information from the second IC card 213, and carries out a procedure for transferring to a state in which communication (registration and call waiting) becomes possible by accessing the network side facilities of the second telephone company 12 and sending/receiving predetermined control information (step S14). The base band processor 203 then determines whether the telephone device 2 is in a state unable to communicate due to, for instance, the telephone device 2 being located outside the wireless communication service area (outside range) of the network side facilities of the second telephone company 12(step S15).

If it is determined that communication is possible in step S15, i.e., when communication with the network side facilities of the second telephone company 12 becomes possible using the subscriber's information of the second IC card 213, the base band processor 203 determines if “1” is set for the flag (step S16).

If it is determined that “1” is set for the flag in step S16, the base band processor 203 reads from the operation procedure database 209 the operation procedure for stopping the telephone answering service supplied by the second telephone company, which corresponds to the telephone number included in the subscriber's information stored in the second IC card 213, and carries out the operation procedure so as to demand the service control station 123 of the second telephone company to stop the telephone answering service (step S17). Then, the service control station 123 operates the database 124 to stop supplying the telephone answering service.

After step S17, the base band processor 203 reads from the operation procedure database 209 the operation procedure for starting the call forwarding service supplied by the first telephone company, which corresponds to the telephone number included in the subscriber's information stored in the first IC card 212, and carries out the operation procedure so as to demand the service control station 113 of the first telephone company to start the call forwarding service (step S18). Then, the service control station 113 operates the database 114 to start supplying the call forwarding service.

After step S18, the base band processor 203 sets “0” for the flag (step S19).

Then, the base band processor 203 waits for a call from the network side facilities of the second telephone company 12 or carries out communication using the subscriber's information of the second IC card 213 (step S20).

After step S20, the base band processor 203 determines whether a change (switch) of the IC cards is carried out by the operation of a user (step S21).

If it is determined that a change of the IC cards is not carried out in step S21, the process returns to the above-mentioned step S15.

On the other hand, if it is determined that a change of the IC cards is carried out in step S21, the process returns to the above-mentioned step S2.

Also, if it is determined that the first IC card 212 is not inserted in the above-mentioned step S3, the process proceeds to step S12. Likewise, if it is determined that communication is not possible in the above-mentioned step S5, the process proceeds to step S12.

If it is determined that “1” is not set in the flag in the above-mentioned step S6, the process proceeds to step S10.

If it is determined that the second IC card 213 is not inserted in the above-mentioned step S13, the process returns to step S2. Likewise, if it is determined that communication is not possible in the above-mentioned step S15, the process returns to step S2.

If it is determined that “I” is not set in the flag in the above-mentioned step S16, the process proceeds to step S20.

Due to the process of steps S2-S11, it becomes possible to make communication using the telephone number of the first IC card 212 (IC card “I”), and to make use of a telephone answering service for the telephone number of the second IC card 213 (IC card “2”). Also, due to the process of steps S12-S21, it becomes possible to make communication using the telephone number of the second IC card 213 (IC card “2”), and to make use of a telephone answering service for the telephone number of the first IC card 212 (IC card “1”).

As explained above, according to the present invention, in the telephone device 2 which is capable of accommodating two IC cards, since the telephone answering service or the call forwarding service is started for the telephone number corresponding to the IC card that becomes unusable when the IC card used is switched, it becomes possible to suitably deal with a call to the telephone number that cannot be answered. Also, according to the embodiments of the present invention, since the telephone answering service or the call forwarding service is stopped for the telephone number corresponding to the IC card that is going to be used when the IC card used is switched, it becomes possible to automatically and normally receive a call to the telephone number corresponding to the IC card that is going to be used.

Note that since the telephone answering service or the call forwarding service has been supplied to the telephone number corresponding to the IC card that is going to be used, a call to the telephone number cannot be received until the supply of such service is cancelled. According to the embodiments of the present invention, cancellation of such service can be automatically achieved.

Note that various alterations and modifications can be added to the abovementioned embodiments. Such alterations and modifications are intended and implied to be within the spirit and scope of the invention.

For example, although the telephone device 2 has a structure in which two IC cards can be inserted in the above embodiments, the present invention is not limited to such a structure and it is possible that the telephone device 2 has a structure in which three or more IC cards are inserted therein.

Also, the present invention may be applied so that the telephone device 2 (the body thereof) possesses the subscriber's information intrinsic to the telephone device, and the telephone device 2 has a structure in which one or more IC cards may be inserted; thereby the telephone device 2 possesses a plurality of the subscriber's information, such as telephone numbers.

Moreover, although the operation procedure database 209 of the telephone device 2 is formed in the memory 208 in the above embodiments, it may be possible that the operation procedure database 209 is formed in a user's area of a storing means which is present in each IC card.

Furthermore, although a user needs to preset the operation procedure for commanding a start or termination of service supplied by a telephone company for each IC card in the above embodiments, the present invention is not limited as such, and it is possible to set the operation procedure by referring to an operation procedure database supplied by a third party, such as a telephone company or a telephone device manufacturer, based on telephone company identification information stored in the IC cards.

In addition, a confirmation procedure to determine whether an IC card is inserted into the IC card slot may be carried out only once when the power of the device is turned on, and the flag may be set or reset only when the IC cards are switched. In this manner, a changing operation for setting of a telephone answering service or a call forwarding service becomes unnecessary when, for instance, an attempt is made to receive a call using a telephone number of the second IC card after using a telephone number of the first IC card and the number of the first IC card becomes unusable due to being outside the service area, and the attempt using the second IC card fails due to the same reason, and then the first IC card is used again.

Also, the operation contents of the operation procedure record which correspond to each IC card may be increased in the operation procedure database 209 so that the operation procedures for a plurality of services may be stored, such as a telephone answering service, a message sending service, and a call forwarding service. Then, when the power is not turned on, i.e., when the telephone numbers of all IC cards cannot be used, it may be possible to receive the telephone answering service for the telephone number of each IC card, cancel the telephone answering service for the telephone number of the IC card that is used when the power is turned on, and switch the telephone answering service of the other telephone numbers to a service assigned by a user, such as a call forwarding service.

Moreover, it is possible to apply the present invention to a portable personal computer or a personal digital assistant (PDA) provided with a wireless communication function instead of the telephone device explained in the above embodiments.

As explained above, according to the present invention, a terminal for wireless communication, such as a telephone, is provided which possesses a plurality of subscriber's information, and a process for commanding a change of settings on a telephone answering service, a call forwarding service, etc., supplied by network side facilities of each telephone number is automatically carried out when telephone numbers contained in each of the plurality of the subscriber's information are switched. Accordingly, a complicated operation which is conventionally required of a user to change settings every time the telephone numbers are switched is no longer necessary. and it becomes possible to provide a terminal for wireless communication that is highly convenient for a user.

Also, according to the present invention, since calls to telephone numbers possessed by the terminal that are not used for communication may be appropriate handled by, for example, supplying a telephone answering service, a call forwarding service, etc., to such telephone numbers, it becomes possible to avoid a situation where calls to telephone numbers not used for communication are not received.

Moreover, according to the present invention, since a setting for a telephone number, which had been used and is no longer going to be used after switching to another number, may be automatically changed to a setting to make use of a telephone answering service, a call forwarding service, etc., when the telephone number is switched to another number that is used for communication, it becomes possible to avoid a situation where calls to telephone numbers not used for communication are not received.

Having thus described several exemplary embodiments of the invention, it will be apparent that various alterations and modifications will readily occur to those skilled in the art. Such alterations and modifications, though not expressly described above, are nonetheless intended and implied to be within the spirit and scope of the invention. Accordingly, the foregoing discussion is intended to be illustrative only; the invention is limited and defined only by the following claims and equivalents thereto.

What is claimed is:

1. A terminal for wireless communication capable of accommodating a plurality of storage devices, each of said storage devices stores information of a subscriber including telephone numbers, said terminal comprising:
a reading unit which reads said information of a subscriber;
a service setting changing unit which is capable of requesting commencement or termination of a service supplied by network side facilities assigned to each of said information of a subscriber;
a switch detection unit which detects switching of said telephone numbers, each of said telephone numbers being used to communicate with a telephone network connected to said network side facilities, and
a control unit which makes said service setting changing unit request commencement of a service supplied by said network side facilities for telephone numbers that are not used for communication when said switching of said telephone numbers is detected by said switch detection unit, and request termination of a service supplied by said network side facilities for at least one of said telephone numbers that is used for communication.

2. A terminal for wireless communication according to claim 1, wherein said service supplied by said network side facilities is at least one of a telephone answering service and a call forwarding service.

3. A terminal for wireless communication according to claim 1, wherein said storage devices are IC cards, and a plurality of said IC cards may be accommodated in a removable manner.

4. A terminal for wireless communication according to claim 1, wherein said information of a subscriber is stored in a body of said terminal and in at least one IC card which is removably accommodated in said body of said terminal.

5. A terminal for wireless communication according to claim 3, wherein said IC cards are Subscriber Identity Modules or User Identity Modules.

6. A terminal for wireless communication according to claim 1, wherein said service setting changing unit is capable of calling a predetermined telephone number assigned to a corresponding telephone network, and transmitting a predetermined signal to said telephone network.

7. A terminal for wireless communication according to claim 1, wherein
said terminal includes a memory unit, and
said service setting changing unit is operated based on a procedure recorded in a database formed in said memory unit.

8. A terminal for wireless communication according to claim 3, wherein said service setting changing unit is operated based on a procedure recorded in said IC card.
